(19) United States
(12) Patent Application Publication
(10) Pub. No.: US 2004/0219854 A1
(43) Pub. Date: Nov. 4, 2004

(54) Elastic composite fabric

(75) Inventors: Dieter Groitzsch, Hirschberg (DE); Hansjoerg Grimm, Weinheim (DE); Nikolaus Hirn, Hirschberg (DE); Eric Knehr, Rodenbach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/830,634

(22) Filed: Apr. 23, 2004

(30) Foreign Application Priority Data
Apr. 30, 2003 (DE) DE 103 19 754.0

(51) Int. Cl. D03D 15/00; D04H 1/00; D04H 3/00; D04H 5/00; D04H 13/00; B32B 27/12; D04H 3/16; D04H 1/54; D04H 3/14; D04H 5/06

(52) U.S. Cl. 442/328; 442/329; 442/352; 442/353; 442/357; 442/394; 442/401; 442/409

(57) ABSTRACT

A composite fabric and a method for manufacturing the composite fabric that includes at least one planar structure and at least one nonwoven fabric thermally bonded to the planar structure via a plurality of welds arranged in a predetermined pattern. A sheet of parallel elastic threads is disposed between the nonwoven fabric and the planar structure, wherein portions of the elastic threads are embedded in the plurality of welds in a stretched state. The composite fabric can be used for manufacturing hygienic products, in particular diapers, including diaper pants.

Priority is claimed to German Patent Application No. DE 103 19 754.0, filed on Apr. 30, 2003, the entire disclosure of which is incorporated by reference herein.

The present invention relates to an elastic composite fabric, which is suitable, in particular, for manufacturing hygienic products such as disposable diapers, as well as a method for manufacturing an elastic composite fabric.

### BACKGROUND

Elastic components have been used for years in disposable diapers for adults and children, or in diaper pants for different purposes. The leg cuffs of such diapers contain single coarse elastic threads adhesively bonded between two layers of nonwoven fabric in order to ensure optimum adjustment to the shape of the body, and thus to prevent leakage of body fluids. The belt region of a diaper can be composed of elastic composite fabrics, also for the purpose of optimum adjustment to the body.

For the same reason, the interlocking part of a mechanical closure system of a diaper can be fixed to an elastic substrate. Both in the case of disposable diapers and diaper pants, a small number of single elastic threads having a very high titer of several hundred to several thousand dtex are incorporated during the diaper manufacturing process. In the process, the elastic threads are adhesively bonded between two layers of nonwoven fabric in a stretched state. Normally, the adhesive is a pressure-sensitive adhesive (PSA), which is applied to the full or partial surface of at least one of the two nonwoven fabric layers. The distance between the individual, neighboring threads, which are aligned parallel to each other, is relatively large, being in the range from several mm to one cm. Upon relaxation of the elongated elastic threads, a very voluminous, coarse, and visually not very appealing structure is formed by the rough pleats or ridges of the inelastic nonwoven fabric layers. Moreover, direct body contact of such rough pleats causes an unpleasant sensation during wear, which, in the extreme case, is associated with impressions on the human skin, and which may promote the development of skin irritations (erythema).

Elastic knitted fabrics, which do not have the disadvantages mentioned above, have not gained acceptance so far, because they are too expensive and too high-quality to be used in a disposable. Knitting-in of elongated elastic threads of relatively fine titer (Raschel technique; Maliwatt) in the range of 44 to about 200 dtex produces visually very appealing, elastic planar textile structures, especially when both the number of stitches (number of loops in the warp direction=machine direction) and the so-called “pitch” (that is, the number of threads or yarns per unit length in a direction transverse to the machine direction) are high. However, such stitch-bonded, elastic products have the problem that the elastic threads are not fixed in the planar structure, and therefore separate from the composite after cutting or punching upon mechanical stress (stretching and relaxation). In order to manufacture a pair of elastic diaper pants from a front part and a back part, the threads would have to be thermally bonded, or adhesively bonded to the nonwoven fabric at the edges prior to punching. This would make the manufacture of a diaper or elastic pants too difficult.

As is generally known, the values of maximum elongation can be arbitrarily adjusted by the level of elongation of the elastic threads prior to adhesive bonding in the inelastic substrate or two inelastic substrates. World Patent Application WO 00/20202 describes the manufacture of a composite fabric from two layers of nonwoven fabric (spunlaced polyester or spunbonded polypropylene nonwoven fabrics) and spandex/elastane threads placed therebetween. The bonding of the spandex elastic threads is accomplished by additionally applying hot-melt adhesive according to the so-called “melt blowing principle” to ensure adhesion of the elastic threads to the nonwoven fabric layers.

U.S. Pat. No. 6,179,946 describes composites, in which spandex/elastane threads laid down in a transverse direction are bonded to the two layers of nonwoven fabric by sprayed on hot-melt adhesive.

U.S. Pat. No. 6,086,571 describes the two parts of an elastic belt of a diaper; the ends of the two parts having attached thereto a hook-type component and a loop component of a mechanical closure system, respectively. Here, it is also mentioned that the elongated elastic threads are bonded to the spundbonded polypropylene nonwoven fabrics by adhesion or hot-melt adhesive.

European Patent Application EP-A-677,284 describes a lateral leakage protection of a diaper, in which an elastomeric thread is incorporated between two layers of hydrophobic, spunbonded polypropylene nonwoven fabric in a special way. Instead of folding a spunbonded nonwoven fabric around the inserted elastomeric thread and hot-melt bonding the elastomeric thread to the two layers of spunbonded nonwoven fabric in order to encapsulate the thread, two separate layers of nonwoven fabric are thermally bonded to each other at their ends with a first embossed pattern so that the elastic thread cannot escape laterally. The continuous embossed patterns can be located on one or both sides of the elastic thread. A second, intermittent embrossed pattern is placed on the elongated elastic thread between the two layers of nonwoven fabric in order to keep the thread captured between the weld lines of the two nonwoven fabric layers. This eliminated the need to additionally apply hot-melt adhesive, and made it possible to prevent stiffening of the fabric; i.e., to achieve better softness.

The products resulting from the described prior art with an additional application of hot-melt adhesive lead to a stiffening of the planar structure and to a high consumption of raw material for bonding the elongated elastic thread, to an increase in complexity of the lamination method, and to relatively high costs.

According to European Patent Application EP-A-677,284, it has, in principle, been possible to incorporate an elastic thread without hot-melt adhesive, but this method is limited to lateral leakage protection of a diaper with a single or only two incorporated threads.

### SUMMARY OF THE INVENTION

It is an object of the present invention to provide elastic composite fabrics that can be used at different positions of a hygienic product, such as a diaper or diaper pants.

A further or alternate object of the present invention to provide elastic composite fabrics which, in terms of softness and textility, come very close to stitch-bonded (raschel-knitted) fabrics with nonwoven fabric as a substrate, i.e., which exceed the known elastic nonwoven fabric/thread laminates that are bonded with hot-melt adhesive or pressure-sensitive adhesive.

The elastic planar structures according to the present invention feature an improved textility and visual design over the previously known nonwoven fabric/thread laminates, which, upon integration as components into a diaper and/or diaper pant, allows them to improve the fit and ability of the diaper and/or diaper pants to adjust to body shapes, thus also improving the comfort during wear, as well as to reduce the risk of leakage of body fluids as compared to known products.

Another further or alternate object of the present invention is to provide elastic composite fabrics, in the structure and production process of which the use of an additional adhesive for bonding the elastic threads to the nonwoven fabric layers can be omitted without thereby impairing the intensity of the embedment or anchorage of the elastic threads in the composite fabric.

The present invention relates to a composite fabric which includes at least one nonwoven fabric, at least one further planar structure, and a parallel sheet of elastic threads arranged therebetween, and which has the feature that the nonwoven fabric is thermally bonded or welded to the further planar structure in the form of a predetermined pattern, and that the elastic threads are embedded in the welds between the nonwoven fabric and the further planar structure at selected locations while in a stretched state.

By embedding the elastic threads between the nonwoven fabric and the further planar structure at the locations of the thermal welds, the elastic threads are incorporated into the composite fabric in a non-slip and non-destructive manner while in a stretched state. This can be accomplished without the presence of an additional adhesive or bonding agent on the elastic threads and/or between the nonwoven fabric and the further planar structure.

The composite fabric according to the present invention has at least one layer of nonwoven fabric and at least one layer of a further planar structure, which can also be a nonwoven fabric, or a film. The nonwoven fabric and/or the further planar structure can have low shrinkage, or be designed to have a tendency to shrink, or to decrease in surface area under the action of wet and/or dry heat. The nonwoven fabric and/or the further planar structure themselves can be elastic or rigid. Preferably, the nonwoven fabric is not elastic.

The nonwoven fabrics used according to the present invention can be composed of any fiber types of the most different titer ranges, for example, of the titers from 0.5 to 10 dtex, preferably from 0.8 to 6.7 dtex, in particular from 1.3 to 3.3 dtex. Besides homofil fibers, it is also possible to use heterofil fibers, such as bicomponent fibers, in crimped or uncrimped form, or mixtures of the most different fiber types.

Preferably, the fibers are pigmented white. For the purpose of coloring, coloring matter can be added to the fiber-forming polymer melt.

To achieve a particularly soft fabric, preference is given to two-dimensionally or three-dimensionally crimped bicomponent fibers.

The nonwoven fabrics used according to the present invention can be formed by different laying methods. Possible layers are wet-laid nonwoven fabrics, carded staple fiber nonwoven fabrics, continuous filament nonwoven fabrics, meltblown nonwoven fabrics, spundbond-meltblown-spundbond nonwoven fabrics (SMS), and spunbond-meltblown nonwoven fabrics (SM). In the latter case, it is advantageous if the meltblown layer in the composite fabric is oriented inwardly, i.e., such that it contacts the elastic threads.

Besides spunbonded nonwoven fabrics, it is preferred to use staple fiber nonwoven fabrics, especially preferably unbonded nonwoven fabrics (webs).

Loose fiber webs that are formed using known web-laying techniques can also be used a the nonwoven fabrics. The fibers can be laid isotropically or in a preferred direction, that is, anisotropically. Prior to lamination with at least one layer of fibrous nonwoven fabric, the fiber web can be pre-bonded using known methods. The fiber web can be composed of the same or different titers of the same fiber. The fibers forming the nonwoven fabric or web can be composed of the most different fibers, for example, of homofil fibers, but also of 100% bicomponent fibers, or a blend of bicomponent fibers and homofil fibers, with the restriction that in the case of a core/sheath fiber, the higher-melting polymer is used as the core component.

Preferred bicomponent fibers are those of the polymer combinations polypropylene/co-polypropylene and polypropylene/polyethylene; very particular preference being given to those blends of bicomponent fibers and homofil fibers in which the homofil fiber is identical to the lower-melting component of the bicomponent fiber. An example of this is a blend of the polypropylene/polyethylene bicomponent fiber with the homofil fiber of polyethylene.

The web or nonwoven fabric layer can be perforated using known methods, or have a net-like structure.

Preference is given to those perforation or structuring methods that are based on the principle of pushing the fibers aside in the form of a pattern. Non-destructive methods of this kind are described in European Patent Applications EP-A-919,212 and EP-A-789,793.

It is also possible to use the perforation methods described below for the film.

The nonwoven fabrics used according to the present invention are preferably non-shrinking under the manufacturing conditions of the composite fabric.

Typically, the nonwoven fabrics used, and their unbonded precursor sheets (webs), have a weight per unit area of 6 to 70 g/m².

It is particularly preferred to use nonwoven fabrics having a low weight per unit area of 6 to 40 g/m². These nonwoven fabrics can be used to make particularly lightweight and, at the same time, highly absorbent composites.

It is particularly preferred to use continuous filament nonwoven fabrics of homofil fibers or bicomponent fibers with olefinic polymer composition.

Examples of these are those made of polypropylene, polyethylene, and olefinic copolymers, which are produced using, for example, either Ziegler-Natta or metallocene catalysts.

The further planar structure can be of any nature. This planar structure can be a fibrous sheet material, such as woven fabric, knitted fabric, netting, lattice, and scrim, or, in particular, a nonwoven fabric, or it can be a film, provided that this further planar structure can be welded to the first nonwoven fabric.

The further planar structure can be composed of linearly aligned, drawn threads or yarns that are oriented parallel to each other. The drawn or stretched threads or monofilaments can be composed by other threads/monofilaments or yarns that are dawn, or undrawn, or drawn to a lesser extent, and which are aligned at an angle to the first ones. The crossing fibers, threads, or monofilaments can be bonded to the other ones through self-bonding, for example, by mechanical bonding, or by welding at the crossing points. However, bonding can also be accomplished using bonding agents, such as aqueous dispersions.

The further planar structure of the composite fabric can be composed of a uniaxially or biaxially stretched film. The film can be made according to the known manufacturing methods, for example, using the blowing method, i.e., it can be stretched in the form of a hose. However, the film can also be formed by extrusion through a flat sheet die, and lengthened by mechanical stretching in the machine direction, or be stretched in a direction transverse to the machine direction using a tenter frame, or by passage through a pair of mating rolls that are grooved in the machine direction.

The usual stretch ratio of the film is up to 5:1 in one or both stretching directions. “Stretch ratio” is understood to be the ratio of the film length before stretching to the film length after stretching.

The film extrudate can be provided with fillers or structure-forming agents, which are known per se, for example, with inorganic particles, such as chalk, talc, or kaolin. Thus, a microporous structure can be produced in a manner known per se by stretching, with the advantage of improved breathing properties.

However, the film can also be perforated by methods known per se prior to stretching so that the perforations expand to larger perforations after stretching.

However, it is also possible to slit the film prior to stretching so that the slits are widened to perforations, especially by stretching at an angle of 90° to the length dimension of the slits.

The film can be weakened in the form of a pattern pior to stretching so that the weakened spots are widened to perforations during stretching. The pattern-like weakening of the film can be accomplished by passage through calender rolls, i.e., by heat and pressure, or by ultrasonic treatment.

The film can be composed of a single layer, or made of several layers, i.e., at least two layers by coextrusion, regardless of whether it is perforated, weakened in the form of a pattern, or slit. One of the two layers, or the two outer layers of the coextruded film can be composed of thermoplastics that are lower melting than the other layer, or the middle layer. The fibers of the nonwoven fabric layers enclosing the shrink film can only be bonded to the lower-melting layer(s) of the coextruded film, and not to the middle layer.

Preferably, the film is composed of a single polymer component, or of at least two layers, including a higher-melting and a lower-melting polymer, and is made by coextrusion. Preferably, the melting or softening range of the film, or of the lower-melting layer of the coextruded film, respectively, is very similar to the melting or softening range of the fibers of the nonwoven fabric.

The materials of the film and of the fibers of the nonwoven fabric are preferably made of the same class of polymers.

Preferred material combinations are a nonwoven fabric of polypropylene or copolypropylene, and a film of polypropylene or a copolymer of propylene with another olefin, or a blend of polypropylene and polyethylene.

The melting range or softening range of the film can be adjusted to those of the continuous filaments in the nonwoven fabric via the degree of stretching of the film. It would also be possible, for example, to weld together a spunbonded polyethylene nonwoven fabric of high density polyethylene (HDPE) or low density polyethylene (LLDPE) as one layer, and a blow-formed and, therefore, very little stretched PP film, or a cast, unstretched PP film, because the welding temperatures are largely equalized due to the very different degrees of stretching of the spunbonded nonwoven fabric and the film.

The present invention also includes the use of a hydrophobic monolithic film, that is, a film that is not permeable to water vapor.

However, for reasons of better comfort during wear and to prevent maceration of the skin, a material combination that is permeable to water vapor is preferred for most applications of the elastic composite fabric.

As is generally known, microporous films which are made of hydrophobic polymer material, or subsequently provided with a hydrophobic finish, are permeable to water vapor and particularly favored for special embodiments of the present invention.

Moreover, the greater softness and high opacity of the microporous films are reasons for the preferred use as a layer of the composite fabric according to the present invention.

Microporous films of hydrophobic polyolefins together with copolymers thereof are advantageous for applications in a disposable diaper.

Polyolefin films whose microporosity is produced by inclusion of stearic acid-coated mineral fillers, such as chalk, into the polymer, and stretching are particularly suitable for use in disposable diapers.

The methods of coextrusion for the production of films can be used here as well.

The microporous polyolefin films are adjusted to the melting or softening ranges of the nonwoven fabric layer, preferably by variation in the stretch ratio (the higher the degree of stretching, the higher is the melting or softening range). The stretching can be carried out in the machine direction, in a direction transverse to the machine direction, or in both directions. Conversely, for the sake of maximum microporosity, it can also be advantageous to strongly stretch the film, and to adjust the fiber polymer of the nonwoven fabric layer to the melting and softening conditions of the microporous film by copolymerization.

To increase opacity and/or for coloring purposes, the film can be white- or color-pigmented, just as the nonwoven fabric.

A particularly preferred variant of the present invention is to combine segmented polyester- or polyether-urethane ureas for producing the elastic threads and polyolefin fibers for the formation the two layers of nonwoven fabric.

Uniaxially or biaxially stretched, extruded plastic nettings can also be used as a layer of a composite structure. The degrees of stretching in the two directions can be equal or different.

Preferably, however, at least one preferred direction is strongly stretched. A “high degree of expansion or stretching” is understood to be a stretch ratio of at least 3:1.

The thread thickness is usually 150 to 2000 μm. “Extruded plastic nettings” are understood to be planar structures with a lattice structure, which is formed in that first parallel-arranged monofilament sheets cross second, also parallel-arranged monofilament sheets at a certain constant angle, and are self-welded to each other at the crossing points. In the case of plastic nettings, the two monofilament sheets are usually composed of the same polymer. However, the thickness and degree of stretching of the two filament sheets can be different.

Also usable as further planar structures are scims, which differ from plastic nettings or lattices in that the crossing filament sheets are not bonded to each other through self-bonding at the crossing points, but by applying bonding agents, such as aqueous polymer dispersions. In this case, the two parallel-oriented monofilament sheets can be composed of different polymers. In the case of scims, it is possible to use both stretched monofilament threads and homofilaments. The angle of the crossing filament sheets can, in principle, be arbitrary. For practical reasons, however, preference is given to an angle of 90°. The filament sheets of the scrim or plastic netting are preferably aligned parallel in the machine direction, and the second filament sheets in a transverse direction, i.e., at an angle of 90° to the machine direction. The distance between the first filaments, which are aligned parallel in the machine direction, is usually in the range between about 0.5 and about 20 mm, preferably between 2 and 10 mm, and that of the second, parallel-aligned filament sheets between 3 and 200 mm.

Besides the further planar structures already described, it is also possible to use woven and knitted fabrics.

The elastic threads used according to the present invention can be of any nature as long as they are elastic and capable of being embedded in the material of the surrounding nonwoven fabric layers or layers of further planar structures while in a stretched state. Typically, the elastic threads are not thermally bonded to the surrounding layers at the weld points, but mechanically fixed in a stretched state by welding the two layers together. However, also possible are material combinations, in which the elastic threads form bonds with the material of the surrounding layers at the weld points. Preferably, however, the elastic threads are only mechanically fixed at these points.

Usable as elastic threads are monofilaments, staple fiber yarns, of multifilament yarns of continuous filaments. The yarns can be employed as flat yarns or in twisted form.

The elastic threads used according to the present invention can be composed of different elastomeric materials.

Generally, the materials are elastomeric plastics. Examples of these are elastomers based on block polyether amides, block polyether esters, polyurethanes, polyurethane ureas, elastic polyolefins, thermoplastic styrene-butadiene-styrene, styrene-isoprene-styrene, styrene-ethylene/propylene-styrene, styrene-ethylene-butadiene-styrene, hydrogenated styrene-butadiene-rubber, and blends thereof with other polymers, for example, with polystyrene, or with polyolefins.

Preferably used are elastic threads of segmented polyester or polyurethane ureas. These threads are preferably spun from dimethyl acetamide or dimethyl formamide solution.

Depending on the demands on the retractive force, it is also possible to use elastomeric thermoplastic threads that are spun from the melt, for example, elastomeric polyurethanes, elastomeric polyesters, or elastomeric polyamides.

The elastic threads can be post-cured before or after the lamination to a composite fabric, thus converting the elastomer to a thermosetting material to a certain extent.

The individual threads of the sheets of parallel elastic threads are typically spaced apart by 0.5 to 15.0 mm, preferably by 1.0 to 10.0 mm.

The titer of the elastic threads is typically in the range of 22 to 500 dtex, preferably in the range of 44 to 300 dtex.

The elastic threads can be in the form of elastic slit-film yarns.

The starting material used for this is an elastomeric film, which is either cast from a polymer solution, or cast-extruded from an elastomer melt. The film is cut into slit-film yarns which are incorporated between the two layers, preferably two nonwoven fabrics, preferably in the machine direction, while in a stretched form and aligned parallel to each other. In the process, the slit-film yarns can be fed in between the two layers in a planar (parallel) manner, or at any angle from 0 to 180°.

In those cases where the width of the slit-film yarns is equal to or greater than the distance of the film centers in the composite fabric, it is preferred for the slit-film yarn to be aligned in the vertical direction.

After the two layers, preferably of PP spunbonded nonwoven fabric, have been welded together in a calender, the slit-film yarns can be incorporated therebetween in a planar manner, or be present in more or less heavily pleated form.

The feeding of the parallel-aligned slit-film yarns is usually accomplished by a comb. If the spacing of the comb teeth is narrower than the strip width, then the slit-film yarn is pleated, or raised to a vertical position.

The films for the manufacture of the slit-film yarn typically have a weight per unit area of 10-400 g/m², preferably 20-200 g/m².

The film width is typically 4-20 mm, preferably 4-10 mm.

This results in a calculated titer of the slit-film yarn of 40 to 8,000 dtex, preferably 80 to 4,000 dtex.

The distance of the folded or non-folded slit-film yarn center from the center of the neighboring (next) slit-film yarn in a direction transverse to the machine direction is typically 2 to 30 mm, preferably 5 to 15 mm. This distance is usually no more than half the film width. This corresponds to a weight per unit area of the slit-film yarn content of at least 20 g/m² and at most 800 g/m², but preferably 40 g/m² to 400 g/m².

Preferably, the direction of movement of the sheet of threads corresponds to the machine direction.

The elastic composite fabric according to the present invention is composed of at least two layers, in particular, two layers of nonwoven fabric or fiber web, and parallel elastomeric threads or yarns, which are located between the two layers and preferably aligned in the machine direction; the composite of the rigid, inelastic nonwoven fabric and the elongated elastic threads being accomplished without using an additional adhesive (hot-melt adhesive or pressure-sensitive adhesive).

In the fully stretched, i.e., non-pleated state, the composite fabric according to the present invention typically has a weight per unit area of 15 to 150 g/m², preferably 15 to 70 g/m².

The maximum elongation m of the elastic composite fabric to the non-pleated state is typically in the range of 10 to 350%, preferably 20 to 250%.

The weight per unit area of the fully relaxed composite fabric typically ranges from 16.5 to 680 g/m², but preferably from 22 to 350 g/m².

In a preferred embodiment, the composite fabric according to the present invention is made up of two layers, both of which are composed of nonwoven fabrics, and between which the parallel elastic threads are incorporated.

In a further preferred embodiment, the composite fabric according to the present invention is made up of at least three layers, two layers of which are composed of nonwoven fabrics between which the parallel elastic threads are incorporated, and at least third layer which covers one of the nonwoven fabrics, and which is preferably a staple fiber nonwoven fabric.

The two layers of the composite fabric according to the present invention between which the elastic threads are incorporated are at least partially composed of fibers of the same fiber polymer, it being possible for the fibers to differ in titer.

Preferably, each of the two layers is entirely composed of the same melt-spun fibers, which are laid either as short staple fibers, as staple fibers, or as continuous filaments.

When selecting the polymer combinations for the composite fabric according to the present invention, care must be taken that the elastomer of the threads essentially does not create a thermal bond with the polymer of the nonwoven fabric layer, or of the layer of the further planar structure, respectively, and that the thermal weld preferably takes place only between the two planar structures.

Preferred combinations of fiber elastomer and fiber in the nonwoven fabric, or in the further planar structure, are listed in the Table below.

| | |
|---|---|
| Fiber elastomer | Polymer in the nonwoven fabric/ |
| | planar structure |
| polyurethanes | polyolefins |
| polyester elastomers | polyolefins |
| SBS¹⁾ and/or SEBS²⁾ | copolyester |
| SBS and/or SEBS (Kraton) | copolyamide |

¹⁾styrene-butadiene-styrene
²⁾styrene-ethylene-butadiene-styrene

Polyolefins, copolyester, and copolyamide can also be the lower-melting component of a bicomponent fiber.

It was a complete surprise that the elongated elastic threads, in spite of their resistance to adhesion with the polymer of the surrounding layers of the two planar structures, were squeezed at the weld zones thereof to such an extent that the elastic threads did not detach, even after numerous, repeated elongation/relaxation cycles.

The fibers of the nonwoven fabric layer(s), or the material of the further planar structure, respectively, must be thermally weldable. Such fibers and materials are understood to include those which fuse together or create a bond under heat and pressure, ultrasound, and infrared energy.

The melting or softening temperatures of the materials of the two layers, for example, of the fiber layers, must be lower than those of the elastic threads, typically at least 25° C. lower.

However, it is also conceivable to subject the elastic thread to cross-linking prior to producing the composite fabric in order to either raise the melting point thereof, or even to bring the elastomer into an infusible state.

The welding between the nonwoven fabric and the planar structure, and the resulting squeezing of the parallel elastic threads of the composite fabric according to the present invention, is preferably accomplished by heat and pressure in the calender nip and/or by ultrasound.

When using shrinkable nonwoven fabrics and/or planar structures, then shrinking can take place only in a preferred direction, or else in both or more than two directions. In the case of several directions, such as in both directions, i.e., in the machine direction and at an angle of 90 degrees to the machine direction, the shrinkage values can be the same or completely different.

The composite fabric according to the present invention can be composed of a nonwoven fabric and a further planar structure that is thermally welded thereto in the form of a predetermined pattern, between which parallel elastic threads are embedded in a stretched state.

However, the further planar structure can also be covered on both sides with a nonwoven fabric, either symmetrically or asymmetrically; i.e., the weights of the two nonwoven fabrics can be different or the same. At least between one nonwoven fabric layer and the further planar structure, which can also be a nonwoven fabric, parallel elastic threads are embedded between the surrounding layers in a stretched state. At the weld zones, the elongated elastic threads are squeezed between the two planar structures in a non-destructive, that is, damage-free manner without melt-bonding to them. It is also possible that two sheets of parallel elastic threads are located between the upper and the lower nonwoven fabric layers and the further planar structure; the threads being embedded in the surrounding layers in a stretched state. In this context, the directions of the sheets of threads can be the same or different from each other.

The thermal welding of the nonwoven fabrics or planar structures for fixing the elastic threads between the planar structures of the inventive composite fabric that are located above and below the elastic threads can have any pattern as long as it allows full immobilization of the elastic threads in a stretched state in the weld zones of the planar structures surrounding these threads. Engraving geometries having single dots or other arbitrary shapes aligned in rows are not suitable if the in-line alignment thereof is selected to be parallel to the alignment of the elastic threads, i.e., usually in the machine direction, because this shape of the welding pattern does not allow fixation of the elastic threads in a stretched state between the two planar structures.

Preferred patterns for thermal welding are continuous lines of different widths in a parallel arrangement. However, it is also possible to conceive of other patterns, leading to rhombus-shaped, waved, zigzag, or circular weld zones.

The weld areas connecting the two layers are typically in the range of 10-40%, preferably 15-30 %, relative to the total area.

In the fully stretched state, the composite fabric according to the present invention generally has a two-dimensional structure. Upon relaxation, a three-dimensional structure will form. Pleats are formed, whose shape, spacing, and height can be varied within wide limits by the engraving design and the degree of elongation.

The composite fabric according to the present invention is distinguished over the prior art in that it has inelastic and elastic regions in a repetitive arrangement in the direction of the sheet of parallel elastic threads, i.e., generally in the machine direction. The elastic region is the region between each two neighboring weld lines on an elastic thread. The elastic, elongated threads are mechanically squeezed in the inelastic regions and embedded in the two layers surrounding them.

The retractive force of the composite fabric can be varied to a great extent by changing the titer of the elastomer threads and their distance from each other.

The present invention also relates to a method for manufacturing the composite fabric described hereinabove, including the steps of:

a) combining at least one nonwoven fabric with a further planar structure and a sheet of parallel elastic threads arranged between the nonwoven fabric and the further planar structure in a stretched state, and

b) welding the sheet of parallel elastic threads in place between the nonwoven fabric and the further planar structure in the form of a predetermined pattern, preferably by heat and calender pressure and/or by ultrasound so that selected regions of each elastic thread are embedded between the nonwoven fabric and the further planar structure at the weld points while in a stretched state.

The thermal welding of the nonwoven fabric and the further planar structure can be accomplished in any way, for example, by calendering with an embossing calender, one roll of which has a predetermined pattern, preferably a regular pattern of lines, or by ultrasonic welding, or by infrared radiation acting on the nonwoven fabric and the further planar structure in a predetermined pattern, respectively.

The sheet of elastic threads can run in any direction relative to the machine direction. Preferably, the sheet runs parallel in the machine direction.

The elastic threads, which are aligned parallel to each other and distributed over the entire width of the fabric, are incorporated between two layers of nonwoven fabric or further planar structure in such a manner that the elastic threads themselves do not adhere to the material of the two layers along predetermined sections, and are connected to the layers only at predetermined weld points, preferably being connected to the material of the two layers along continuous, uninterrupted weld lines.

The weld lines can, in principle, have any desired form, and typically form an angle between 45 and 90° to the parallel-aligned elastic threads. The angle can but does not have to be the same at all locations.

In the method according to the present invention, the elastic threads or slit-film yarns are placed between the two layers, preferably the two nonwoven fabric layers, while in a stretched state.

The desired level of elongation can be adjusted by the speed differential of the feed and take-up devices of the manufacturing apparatus, for example, of the thread take-up device and the calender rolls. The elastic threads can be wound on warp beams or sectional warp beams. However, the take-up can also be unwound from bobbins that are stuck on a creel, and be fed to a calender nip.

Above and below the elongated threads or slit-film yarns, the two layers, preferably of embossed-bonded, spunbonded polyolefin nonwoven fabrics, are fed to a calender nip.

In a preferred embodiment, one roll has a smooth surface and the other is provided with a continuous embossed line pattern. In case the two layers differ in weight, the layer having the lower weight per unit area is brought into contact with the smooth roll.

Preferably, the edges of the line-shaped engraving are slightly rounded. In this manner, it is ensured that the elastic, elongated threads or slit-film yarns, which are heated and pressed in the calender nip, are effectively prevented from being cut off or through.

Besides calendering with heat and pressure in a calender, the manufacture of the elastic composite fabric can also be accomplished using ultrasonic technology.

After the fabric has been calendered to an elastic composite fabric, it can be rolled up in a stretched state. However, it is advantageous to relax the fabric after it has passed through the calender (for example, by one or more rolls running slower than the calender rolls), and, according to common practice for elastic textiles, to subject the composite fabric to steam treatment in this relaxed state for the purpose of secondary shrinkage the elastic threads, equalization of the shrinkage force over the entire fabric width and fabric length, but also to remove portions of solution and spin finishes that might have remained from the spinning process.

Upon completion of this aftertreatment, the fabric is rolled up again, preferably in a stretched state.

The composite fabric according to the present invention can be used, in particular, for manufacturing hygienic products, in particular diapers, including diaper pants. This use also forms part of the subject matter of the present invention.

### BRIEF DESCRIPTION OF THE DRAWINGS

The present invention will be described in more detail with reference to the drawings, in which:

FIG. 1 illustrates an embodiment of the composite fabric according to the present invention;

FIG. 2 shows the composite fabric according to FIG. 1 in a cross-section along line A-A;

FIG. 3 illustrates the composite fabric according to FIG. 1 in a relaxed state in a cross-section along line B-B; and

FIG. 4 illustrates a device for manufacturing the composite fabric according to the present invention.

### DETAILED DESCRIPTION

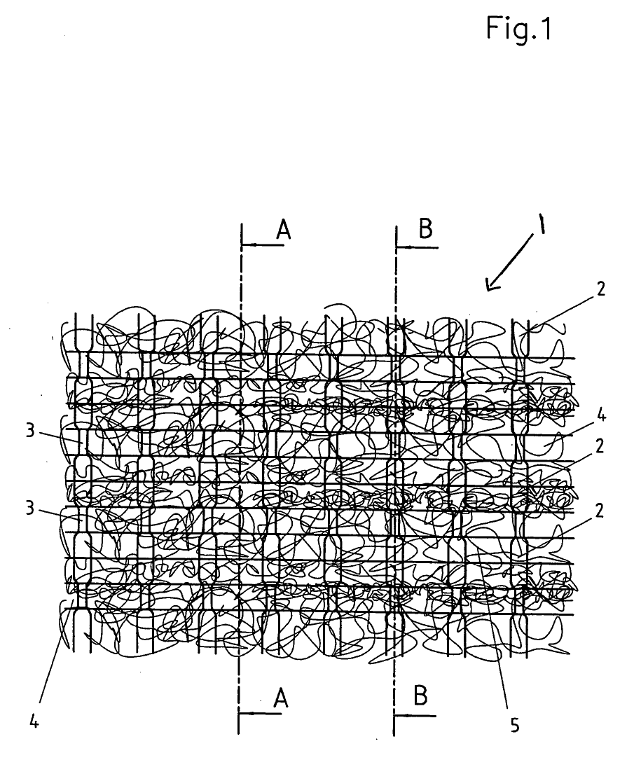

One of the many variants of the fibrous sheet material according to the present invention is schematically shown in FIG. 1. In this case, the composite is composed of a total of three nonwoven fabric layers. The composite fabric (1) is shown in a top view, the elastic threads incorporated between the nonwoven fabric layers being plotted for better understanding.

The fibers (5) of the two nonwoven fabric layers or fiber webs are intensively fused (autogenously welded) together along weld lines (4).

In the version of the composite fabric shown in FIG. 1, the incorporated elastic fibers are in the relaxed (i.e., relieved) state. Because the elastic fibers were combined with the two rigid, inelastic nonwoven fabric layers into a composite fabric while in a stretched state, three-dimensional structures are formed upon relaxation of the threads with pleats on both sides of the thread plane, as is generally known.

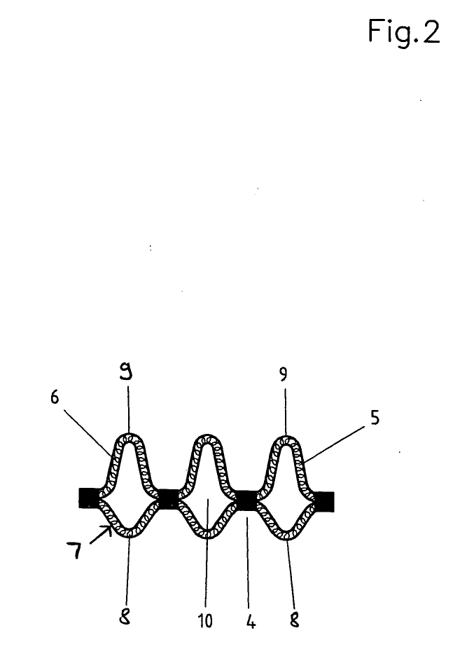

The pleating is shown in FIG. 2 in the cross-section along line A---A.

Upon relaxation, the two nonwoven fabric layers (6) and (7) become corrugated, with the apices (8) and (9) being symmetrical with respect to the weld points (4) on both sides. These corrugations form cavities (10).

In FIG. 1, it is evident that, in the fully or partially relaxed composite fabric, the elastic thread, which is preferably aligned in the machine direction, has alternating regions of higher thickness (titer) and lower thickness (titer).

Within weld regions (4), the elastic thread is mechanically squeezed to such an extent that its stretched state, or rather, the thickness (3) during the manufacture of the composite fabric, remains freezed, totally unlike the regions of the elastic thread between weld zones (4), where the thread can assume a greater thickness (2) largely unhindered by the nonwoven fabric, the greater thickness corresponding to the degree of relaxation.

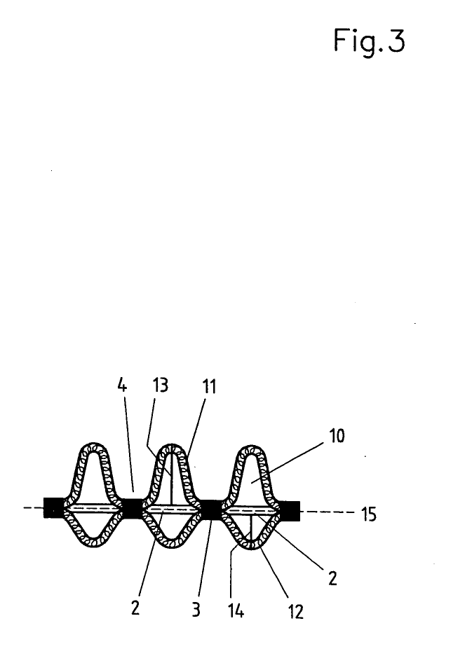

FIG. 3 shows a cross-section of the elastic composite fabric in a relaxed state along line B-B. At weld points (4), the elastic thread is shown with its thin spots (=stretched state) (3), and its thick spots (2) (fully or partially relaxed state). Outside the weld points (4), the layer thicknesses (11) of the upper nonwoven fabric and the layer thicknesses (12) of the lower nonwoven fabric are determined by their weight and bonding conditions. The apex heights (13) and (14) of the corrugations on both sides of the thread plane can be the same or different, and depend largely on the manufacturing conditions, for example, on the pairings of calender rolls used. If, in the case of bonding by means of heat and pressure, a smooth calender roll and an engraved calender roll are used, then the apex heights of a relaxed composite fabric on which the engraving is impressed are greater than on the opposite side. Within the scope of this specification, “apex heights” (13) and (14) are understood to be the distances between the apices (8) and (9) and the thread plane (15), respectively.

The higher the percentage of contraction (relaxation), and the softer and lighter the non-stretchable nonwoven fabrics, the smaller are cavities 10. Especially in the case of high relaxation, which corresponds to a high pre-tension of the elastic thread during the manufacture of the composite fabric, the cavity can completely disappear and, in particular in the case of light and soft nonwoven fabric layers, the corrugations can fold down. This folding down can be achieved in a controlled manner by the application of pressure.

When using fibers do not include white pigment, the weld regions (4) have an essentially transparent appearance. In the case of applications that allow high opacity, it is advantageous to use as high an amount of white pigmentation as possible, for example, of titanium dioxide, both for the nonwoven fabric and the elastic threads. As an additional advantageous measure to increase opacity, it offers itself to press the corrugations flat by calendering, thus covering the transparent weld points.

It is known to one skilled in the art that this flattening of the composite fabric should be carried out without the action of heat, or rather, at such low temperatures that the folded-down nonwoven fabric pleats cannot stick together, which would reduce the elasticity of the composite fabric.

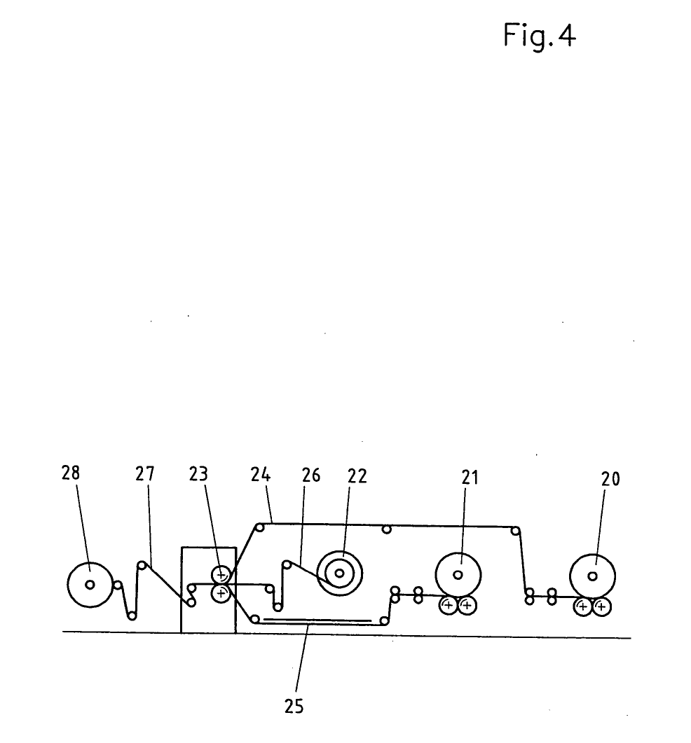

The composite fabrics shown in FIGS. 1 through 3 can be produced in a device according to FIG. 4.

In this case, unwinding units (20) and (21) relate to two nonwovern fabric layers, and unwinding unit (22) represents a warp beam unwinding unit including a warp stop motion (for example, with about 50.000 m). Also shown is a calender (23), to which nonwoven fabrics (24) and (25), as well as the sheet of parallel elastic threads (26), are fed and in which they are joined together at predetermined points under the action of heat and pressure. The composite fabric (27) produced is wound onto roll (28).

The following examples illustrate the present invention without limiting it.

### EXAMPLE 1

Elastane threads having a titer of 78 dtex, which had been spun from segmented polyurethane in dimethyl acetamide solvent and wound at a prestretch of 40%, were unwound at a rate of 2.5 m/min from a sectional warp beam, which had been prepared for a warp of 18 threads/inch (which corresponds to 18 threads/2.54 cm).

The threads were guided parallel to each other by two rakes for 18 threads/inch (which corresponds to 18 threads/2.54 cm), the two rakes being aligned at an angle of 90° to the machine direction. One of the two 50 cm-wide rakes was mounted immediately downstream of the warp beam, and the second was mounted upstream of the two calender rolls. The rakes were taken from a Raschel knitting machine. The elastane threads, which where aligned parallel in the machine direction, were fed to and squeezed in the nip of a smooth calender roll and an engraved calender roll, both of which were made of stainless steel. The speed of the calender rolls was 5 m/min. The engraved roll used was one with linear raised portions running nearly transverse to the machine direction, which is hereinafter referred to “Line Seal engraved roll”.

Specifications of the Line Seal engraved roll:

Width of lines: 1.00 mm

Spacing of two line centers: 4.00 mm

Weld area: 25%

Engraving depth: 0.90 mm

Line angle, measured transverse to the machine direction: 0.8°

The edges of the Line Seal engraved roll were rounded prior to use in order to prevent the elongated elastane threads from being cut off or through during calendering.

The angle of 0.8° was selected to ensure smooth running of the calender rolls (without supporting edges) (that is, to prevent the rolls from rattling).

Above and below the stretched elastane threads, in each case one white delustered spunbonded polypropylene nonwoven fabric having a weight per unit area of 17 g/m² each were supplied immediately upstream of the roll nip, and bonded by Line Seal welds in the calender nip to form a three-layer composite fabric. The polypropylene nonwoven fabrics had a balanced ratio between the maximum tensile strength in the longitudinal and transverse directions, and had been pigmented with 0.9% of titanium dioxide to increase opacity.

The temperature of both rolls was 145° C., and the line pressure was 35 N/mm.

The composite fabric was rolled up at a rate of 5 m/min, i.e., in a stretched state. Upon unwinding and complete relaxation of the composite fabric, a fabric formed which had symmetrical pleatings on both sides of the elastane thread plane and between the Line Seal welds.

Surprisingly, the elastane threads did not become loose or slip out of the composite between the fusion or weld points of the two layers of spunbonded polypropylene nonwoven fabric, even after numerous, repeated elongation-and-relaxation cycles until the complete elimination of pleats.

This is surprising in as much as there is a great difference of the thermal welding temperature of the layers of spunbonded polypropylene nonwoven fabric (here 145° C.) and the segmented polyurethane urea of the elastane threads (softening temperature approximately 190-200° C.).

In the stretched state (i.e., in the non-pleated state of the spunbonded nonwoven fabric layers) of the composite fabric, which is elastic in the machine direction, the resulting weights per unit area of the three layers were as follows:

| | Weight per unit |
|---|---|
| Components of the composite fabric | area in g/m² |
| spunbonded polypropylene nonwoven fabric layer 1 | 17.00 |
| 78 dtex elastane yarn with 18 yarns/inch | 1.974 |
| spunbonded polypropylene nonwoven fabric layer 2 | 17.00 |
| Total | 35.974 |

The weight per unit area F of the elastane yarns was calculated according to the following relationship:

$$F = \frac{T * g * 100}{10000 * 2.54 * ( 1 + 0.01 * v ) * k / a}$$

where

T=titer of the elastane yarn in dtex

g=yarn pitch in number/inch

v=prestretch of the elastane yarn on the warp beam in %

a=unwinding speed from the warp beam in m/min

k=calender speed in m/min.

Calculation for Example 1:

t=78 dtex

g=18/inch (which corresponds to 18/2.54 cm)

v=40%

a=2.5 m/min

k=5.0 m/min

According to the above formula, the resulting value for F is 1.974 g/m².

The composite fabric from Example 1 was marked at two points spaced apart in the machine direction while in a relaxed state, then stretched until the pleats had completely disappeared, and then the distance of the two marks were measured again.

The elongation, here referred to as maximum elongation, was measured from the ratio of the distance in the elongated state to the distance in the non-elongated state.

In Example 1, a maximum elastic extensibility of up to 95% was observed.

In the present invention according to Example 1, a distinction must be made between two alternating regions in the machine direction. The Line Seal-welded regions, which represented a proportion of 25% of the total area, and the regions between the weld lines, which represented an area of 75% in the case where the composite fabric had been stretched until the pleats had completely disappeared.

The welded regions (25%) are completely inelastic and non-stretchable. Here, the elastane thread was in a state corresponding to an elongation by a factor of 2.8, and thus, to a titer of 27.86 dtext, entirely independently of the elongation state in which the composite fabric was.

The maximum elastic extensibility of the composite fabric of only 95% (i.e., elongation by a factor of 1.95) clearly shows that the two layers of spunbonded polypropylene nonwoven fabric prevent total relaxation of the elastane thread to its initial titer of 78 dtex.

The proportion of weight per unit area f of the relaxed, new composite fabric can be calculated from the following relationship:

f=0.01*w*F+(1+0.01*m−0.01*w)*F

where

w=proportion by area of the weld zones in %

p=proportion by area of the regions between the weld zones in the maximally stretched (i.e., non-pleated) state in % (which corresponds to p=100−w)

m=maximum elongation of the composite fabric (to the non-pleated state) in %

F=weight per unit area of the elastane yarns

The calculation for Example 1 yielded:

w=25%

p=75%

m=95%

F=1.974.

The value for f calculated from this according to the above formula is

f=1.95−1.974=3.8493 g/m² elastance threads,

with f being distributed among the welded and unwelded regions fᵥ and fᵤ as follows:

fᵥ=0.01*w*F fᵤ=f−fᵥ

This yields values for fᵥ and fᵤ of

fᵥ=0.25*1.974=0.4935 g/m²

fᵤ=3.3558 g/m²

To determine the titer, and thus also the elongation state, of the elastane thread in the composite of Example 1 upon relaxation, the following formula must be used:

$${M}_{p} = ( \frac{1 + 0.01 * m - 0.01 * w}{0.01 * p} - 1 ) * 100 ( \% )$$

where

Mₚ is the maximum elongation within the pleat areas in % and the other variables have the meaning indicated hereinabove.

The calculation for Example 1 yields:

Mₚ=126.66%.

Due to the fact that 25% of the area, in terms of the non-pleated, stretched state, remains completely inelastic, the maximum possible elongation value is reduced from 126.66% to 95%, relative to the total area.

Both in the relaxed and stretched states of the new composite fabric from Example 1, the elastane yarn has a titer T_{d} of

$${T}_{d} = \frac{T}{( 1 + 0.01 * v ) * k / a} dtex vor .$$

In this connection, the variables have the meaning indicated hereinabove.

Thus, the calculation for Example 1 yields a value of Td=78/2.8=27.857 dtex.

For the relaxed regions of elastane yarn between the weld zones of the composite fabric, the Tₑ is calculated according to the following relationship:

Tₑ=T_{d}*(1+0.01*Mₚ).

In this connection, the variables have the meaning indicated hereinabove.

Thus, the calculation for Example 1 yields a value of Tₑ=27.857*2.2666=63.14 dtex.

Thus, the two layers of spunbonded polypropylene nonwoven fabric having a weight of 17 g/m² prevent total relaxation of the elastane yarns from 27.857 dtex to their initial state of 78 dtex, but remain blocked at a titer of 63.14 dtex, which corresponds to a return by only 126.66% instead of 180%.

The weight per unit area of the composite fabric was 38 g/m² after it had been stretched until the pleats had completely disappeared, and 74 g/m² in the relaxed state.

Test for Elastic Behavior:

The test for tensile-elastic behavior was performed according to DIN 53 835, Part 1 and Part 14.

To this end, 25 mm-wide strips from Example 1 were subjected to a stress/strain relaxation test for three cycles, each time until a maximum elongation with a take-up speed of 500 mm/min. The measurement was started with a force before movement onset of 0.05 N/25 mm. Cycle 1 was run for 20 seconds (10 seconds for the loading curve to 120% max. elongation, and another 10 seconds for relaxation). Immediately thereafter, the second hysteresis cycle was started for the same duration as in the first cycle. After remaining in the relaxed state for 60 seconds, the third cycle was run.

Table 1 below shows tensile forces Z for different elongations of 40, 60 and 100 and 120%, as well as elongation ε at 0.05 N/25 mm and 0.1 N/25 mm, both in the loading and relaxation curves of the three cycles.

TABLE 1

| | Tensile force Z in N/25 mm | | | | | |
|---|---|---|---|---|---|---|
| | at different percentages of | | | | | |
| | elongation | | | | Elongation ε in % at | |
| hysteresis | 40% | 60% | 100% | 120% | 0.05 N/25 mm | 0.1 N/25 mm |
| cycle 1 | 0.36 | 0.51 | 1.11 | 15.81 | 0.1 | 3.1 |
| loading | | | | | | |
| cycle 1 | 0.19 | 0.29 | 0.57 | 15.51 | 16.1 | 22.8 |
| relaxation | | | | | | |
| cycle 2 | 0.26 | 0.38 | 0.75 | 14.83 | 8.9 | 13.9 |
| loading | | | | | | |
| cycle 2 | 0.19 | 0.29 | 0.56 | 14.76 | 16.7 | 24.2 |
| relaxation | | | | | | |
| cycle 3 | 0.29 | 0.41 | 0.79 | 14.68 | 0.7 | 10.6 |
| loading | | | | | | |
| cycle 3 | 0.19 | 0.29 | 0.56 | 14.59 | 14.59 | 23.4 |
| relaxation | | | | | | |

The tensile force Z after the relaxation cycles is also referred to as the so-called “retractive force”. Of particular importance for diaper pants is, for example, the retractive force at 40% elongation after relaxation cycle 3.

### EXAMPLE 2

The two polypropylene nonwoven fabrics of Example 1 having a weight of 17 g/m² were replaced by two lighter ones having a weight of only 8 g/m². The conditions described in Example 1 remained unchanged.

In the stretched state (i.e., in the non-pleated state of the spunbonded nonwoven fabric layers) of the composite fabric, which is elastic in the machine direction, the resulting weights per unit area of the three layers were as follows:

| | Weight per unit |
|---|---|
| Components of the composite fabric | area in g/m² |
| spunbonded polypropylene nonwoven fabric | 8.000 |
| layer 1 | |
| 78 dtex elastane yarn with 18 yarns/inch | 1.974 |
| spunbonded polypropylene nonwoven fabric | 8.000 |
| layer 2 | |
| Total | 17.974 |

The maximum elastic elongation m determined was 120%, resulting in the following weights for the composite fabric in the relaxed state:

| | Weight per unit |
|---|---|
| Components of the composite fabric | area in g/m² |
| spunbonded polypropylene nonwoven fabric layer 1 | 17.600 |
| 78 dtex elastane yarn with 18 yarns/inch | 4.343 |
| spunbonded polypropylene nonwoven fabric layer 2 | 17.600 |
| Total | 39.543 |

The adjusted values for m of 120%, which are higher compared to Example 1 (Example 1: 95%), clearly show that when two layers of spunbonded polypropylene nonwoven fabric having a lower weight per unit area were used, the elongated elastane threads could return to their original state (78 dtex) to a greater degree than in Example 1.

The calculations for m=120% yield the following data for Example 2:

| | Unit | Value |
|---|---|---|
| F | m² | 4.3428 |
| fᵥ | /m² | 0.4935 |
| fᵤ | G/m² | 3.8493 |
| Mₚ | % | 160% |
| T_{d} | dtex | 27.857 |
| Tₑ | dtex | 72.43 |

Thus, after relaxation, the elastane yarns in the composite fabric were in a state in which they were elongated by 7.7% compared to the state in 78 dtex, while in Example 1 this value was 23.5%, which is markedly higher.

Measuring results of the hysteresis tests

| | Tensile force Z in N/25 mm | | | | | |
|---|---|---|---|---|---|---|
| | at different percentages of | | | | | |
| | elongation | | | | Elongation ε in % at | |
| hysteresis | 40% | 60% | 100% | 120% | 0.05 N/25 mm | 0.1 N/25 mm |
| cycle 1 | 0.34 | 0.47 | 0.78 | 1.00 | 0.8 | 3.2 |
| loading | | | | | | |
| cycle 1 | 0.19 | 0.26 | 0.48 | 0.98 | 14.1 | 21.4 |
| relaxation | | | | | | |
| cycle 2 | 0.24 | 0.35 | 0.62 | 0.93 | 4.9 | 11.3 |
| loading | | | | | | |
| cycle 2 | 0.18 | 0.25 | 0.47 | 0.92 | 14.1 | 22.4 |
| relaxation | | | | | | |
| cycle 3 | 0.27 | 0.36 | 0.64 | 0.91 | 0.1 | 9.8 |
| loading | | | | | | |
| cycle 3 | 0.19 | 0.26 | 0.48 | 0.90 | 14.9 | 22.9 |
| relaxation | | | | | | |

### EXAMPLE 3

In Example 3, the starting materials used for producing the elastic composite fabric were the same as in Example 2, i.e., polyurethane yarn of 78 dtex, and two layers of spunbonded polypropylene nonwoven fabric of 8 g/m² each.

The unwinding speed from the warp beam was 1.0 m/min. The calender speed was 3.0 m/min.

After passing through the calender, the fabric was rolled up at a rate of about 1.10 m/min, not in a stretched, but in a relaxed state.

The measurement of the maximum elastic elongation m was carried out after the fabric had been stored in the fully relaxed state for one week.

In contrast to Examples 1 and 2, markedly different spacing conditions were measured in the state of maximum elastic elongation than corresponded to the geometry of the LineSeal engraved roll. Theoretically, in the completely non-pleated state m, the resulting value for the width of the weld lines should be 1.000 mm, and the resulting distance for the regions between the weld lines should be 3.000 mm. However, after analysis of scanning electron microscopic pictures, an average weld width b₂ of only 0.694 mm (instead of b₁=1.000 mm) was determined, and a distance b₄=2.046 mm (instead of b₃=3.000 mm) was found for the regions between the weld lines. Thus, both the welded and non-welded regions were reduced by an average of 29%, relative to the geometry of the LineSeal roll.

The weight per unit area of the elastic composite fabric according to Example 3 was determined to be 61.31 g/m² in a relaxed state. For the maximally stretched (non-pleated) state with an elongation of 190%, a weight per unit area of 21.1 g/m² was calculated from this.

According to the formula given above, the following value was calculated for elastane thread weight F in the maximally stretched state of the composite fabric:

$$F = \frac{78 * 18 * 100}{10000 * 2.54 * 1.4 * 3} = 1.316 g \text{/} {m}^{2}$$

Consequently, if the fabric were rolled up in the stretched, non-pleated state, the following weights per unit area would result for the structure of the composite fabric:

| | Weight per unit |
|---|---|
| Components of the composite fabric | area in g/m² |
| spunbonded polypropylene nonwoven fabric layer 1 | 8.00 |
| 78 dtex elastane yarn with 18 yarns/inch | 1.316 |
| spunbonded polypropylene nonwoven fabric layer 2 | 8.00 |
| Total | 17.316 |

However, because the fabric had been rolled up in a tensionless manner to the greatest extent possible, the width of the LineSeal weld zone was reduced from 1.000 to 0.704 mm, which, in all probability, is only due to the restoring force of the elastane thread. This shortening of weld zones could only happen immediately after leaving the calender nip, i.e., as long as the molten mass was still soft. The shortening of the weld width was associated with a corresponding increase in the weight per unit area or in titer of the yarn within the weld zone.

1.316*b₂/b₁=1.316*1/0.694=1.896 g/m².

The proportion by weight of the two layers of spunbonded polypropylene nonwoven fabric had to increase by the same factor, accordingly.

Some parameters of such shortened composite fabrics can be calculated according to the following formulas, where:

B1=width of the LineSeal engraving in mm

B2=width of the LineSeal weld zone in the composite fabric

S1=weight per unit area in g/m² of the nonwoven fabric layer used

S2=weight per unit area in g/m² of a nonwoven fabric layer in the composite fabric

F1=proportion of weight per unit area of elastane of a fabric that is rolled up in the fully stretched (non-pleated) state

F2=proportion of weight per unit area of elastane of a fabric that is rolled up in a nearly tensionless manner

F3=proportion of weight per unit area of a layer of nonwoven fabric in the embossed zone of the composite fabric that is rolled up in a nearly tensionless manner

F4=proportion of weight per unit area of a layer of nonwoven fabric in the unembossed zones of a fully stretched (non-pleated) fabric

Fv=area reduction factor

Gkg=weight per unit area of the composite fabric in a fully stretched (non-pleated) state

Gkr=weight per unit area of the composite fabric in the fully relaxed state

The following is calculated:

$$\begin{matrix}Fv = \frac{B2 + p / w * B1}{B1 + p / w * B1} = \frac{0.694 + 3 * 1}{1 + 3} = \frac{3.694}{4} \\ F1 = 1.316 g \text{/} {m}^{2} \\ F2 = F1 * \frac{B1}{B2} = F1 * 1.441 = 1.316 * 1.441 = 1.8962 g \text{/} {m}^{2} \\ F3 = 0.01 * w S1 * \frac{B1}{B2}\end{matrix}$$

For Example 3: F3=0.25*8*1.441=2.882 g/m².

F4=0.01*p*S1

For Example 3: F4=0.75*8=6 g/m².

Gkg=(F2+2*F3+2*F4)*I/Fv=(1.8962+2*2.882+2*6)*4/3.694=21.289 g/m².

Given a maximum elastic elongation of 190%, the following results were obtained in a relaxed state

Gkr=(1+0.01*m)*Gkg

For Example 3 where m=190%

Gkr=2.9*21.289=61.738 g/m²

Thus, in the stretched state (i.e., in the non-pleated state of the spunbonded nonwoven fabric layers) of the composite fabric, which is elastic in the machine direction, the resulting weights per unit area of the three layers were as follows:

| | Weight per | Weight per |
|---|---|---|
| | unit area in | unit area in |
| Components of the composite fabric | g/0.925 m² | g/m² |
| Proportion by weight F4 of PP spunbonded | 6.000 | 6.497 |
| nonwoven fabric layer 1 in the | | |
| unembossed zones | | |
| Proportion by weight F3 of PP spunbonded | 2.882 | 3.121 |
| nonwoven fabric layer 1 in embossed zone | | |
| 78 dtex elastane yarn with 18 yarns/inch | 1.896 | 2.053 |
| Proportion by weight F3 of PP spunbonded | 2.882 | 3.121 |
| nonwoven fabric layer 1 in embossed zone | | |
| Proportion by weight F4 of PP spunbonded | 6.000 | 6.497 |
| nonwoven fabric layer 1 in the | | |
| unembossed zones | | |
| Total | 19.99 | 21.289 |

Measuring results of the hysteresis tests for a maximum elongation of 60%

| | Tensile force Z in N/25 mm | | | | | |
|---|---|---|---|---|---|---|
| | at different percentages of | | | | | |
| | elongation | | | | Elongation ε in % at | |
| hysteresis | 30% | 40% | 50% | 60% | 0.05 N/25 mm | 0.1 N/25 mm |
| cycle 1 | 0.40 | 0.45 | 0.53 | 0.60 | 0.20 | 0.90 |
| loading | | | | | | |
| cycle 1 | 0.25 | 0.34 | 0.55 | 0.60 | 7.00 | 13.20 |
| relaxation | | | | | | |
| cycle 2 | 0.34 | 0.44 | 0.54 | 0.58 | | |
| loading | | | | | | |
| cycle 2 | 0.24 | 0.32 | | 0.58 | 8.30 | 13.70 |
| relaxation | | | | | | |
| cycle 3 | 0.36 | 0.43 | | 0.58 | 2.10 | 3.90 |
| loading | | | | | | |
| cycle 3 | 0.25 | 0.31 | | 0.58 | 8.70 | 13.00 |
| relaxation | | | | | | |

Measuring results of the hysteresis tests for a maximum elongation of 80%

| | Tensile force Z in N/25 mm | | | | | |
|---|---|---|---|---|---|---|
| | at different percentages of | | | | | |
| | elongation | | | | Elongation ε in % at | |
| hysteresis | 30% | 40% | 60% | 80% | 0.05 N/25 mm | 0.1 N/25 mm |
| cycle 1 | 0.35 | 0.40 | 0.55 | 0.72 | 0.00 | 1.50 |
| loading | | | | | | |
| cycle 1 | 0.21 | 0.27 | 0.42 | 0.70 | 9.60 | 14.90 |
| relaxation | | | | | | |
| cycle 2 | 0.29 | 0.36 | 0.50 | 0.70 | 3.50 | 8.10 |
| loading | | | | | | |
| cycle 2 | 0.20 | 0.27 | 0.41 | 0.70 | 9.70 | 15.10 |
| relaxation | | | | | | |
| cycle 3 | 0.39 | 0.39 | 0.51 | | 0.70 | 5.30 |
| loading | | | | | | |
| cycle 3 | 0.19 | 0.26 | 0.42 | | 9.30 | 17.10 |
| relaxation | | | | | | |

Measuring results of the hysteresis tests for a maximum elongation of 110%

| | Tensile force Z in N/25 mm | | | | | Elongation ε | |
|---|---|---|---|---|---|---|---|
| | at different percentages of | | | | | in % at | |
| | elongation | | | | | 0.05 N/ | 0.1 N/ |
| hysteresis | 30% | 40% | 60% | 100% | 110% | 25 mm | 25 mm |
| cycle 1 | 0.36 | 0.42 | 0.57 | 0.95 | 0.99 | 0.00 | 1.70 |
| loading | | | | | | | |
| cycle 1 | 0.18 | 0.23 | 0.34 | 10.76 | 0.99 | 12.1 | 18.50 |
| relaxation | | | | | | | |
| cycle 2 | 0.27 | 0.34 | 0.47 | 0.87 | 0.94 | 3.90 | 5.90 |
| loading | | | | | | | |
| cycle 2 | 0.17 | 0.23 | 0.34 | 0.75 | 0.95 | 12.20 | 21.00 |
| relaxation | | | | | | | |
| cycle 3 | 0.30 | 0.35 | 0.49 | 0.87 | 0.94 | 2.60 | 5.50 |
| loading | | | | | | | |
| cycle 3 | 0.17 | 0.24 | 0.34 | 0.73 | | 11.90 | 20.90 |
| relaxation | | | | | | | |

Measuring results of the hysteresis tests for a maximum elongation of 150%

| | Tensile force Z in N/25 mm | | | | | |
|---|---|---|---|---|---|---|
| | at different percentages of | | | | | |
| | elongation | | | | Elongation ε in % at | |
| hysteresis | 40% | 60% | 100% | 150% | 0.05 N/25 mm | 0.1 N/25 mm |
| cycle 1 | 0.45 | 0.58 | 0.90 | 1.47 | 0.20 | 2.00 |
| loading | | | | | | |
| cycle 1 | 0.21 | 0.28 | 0.44 | 1.45 | 18.10 | 25.00 |
| relaxation | | | | | | |
| cycle 2 | 0.32 | 0.41 | 0.65 | 1.36 | 1.80 | 13.60 |
| loading | | | | | | |
| cycle 2 | 0.18 | 0.27 | 0.41 | 1.32 | 18.40 | 26.60 |
| relaxation | | | | | | |
| cycle 3 | 0.30 | 0.42 | 0.69 | 1.33 | 0.20 | 11.60 |
| loading | | | | | | |
| cycle 3 | 0.19 | 0.27 | 0.45 | 1.32 | 18.90 | 26.90 |
| relaxation | | | | | | |

Measuring results of the hysteresis tests for a maximum elongation of 200%

| | Tensile force Z in N/25 mm | | | | | |
|---|---|---|---|---|---|---|
| | at different percentages of | | | | | |
| | elongation | | | | Elongation ε in % at | |
| hysteresis | 40% | 60% | 100% | 200% | 0.05 N/25 mm | 0.1 N/25 mm |
| cycle 1 | 0.42 | 0.53 | 0.87 | 3.33 | 0.20 | 0.70 |
| loading | | | | | | |
| cycle 1 | 0.15 | 0.22 | 0.31 | 3.25 | 22.10 | 30.90 |
| relaxation | | | | | | |
| cycle 2 | 0.24 | 0.33 | 0.51 | 3.00 | 1.80 | 17.40 |
| loading | | | | | | |
| cycle 2 | 0.14 | 0.20 | 0.29 | 2.96 | 24.30 | 31.90 |
| relaxation | | | | | | |
| cycle 3 | 0.26 | 0.36 | 0.53 | 2.89 | 0.40 | 1.00 |
| loading | | | | | | |
| cycle 3 | 0.15 | 0.23 | 0.31 | 2.87 | 22.00 | 30.00 |
| relaxation | | | | | | |

### EXAMPLE 4

In Example 4, the same elastane thread (78 dtex), the same thread pitch in a direction transverse to the machine direction (18/inch), and the same thread tension on the sectional warp beam (40%) as in Examples 1 through 3 were used.

A spunbonded polypropylene nonwoven fabric having a weight of 8 g/m² ran below the stretched elastane thread plane and, from above, a longitudinally oriented web having a weight of 18 g/m², which was composed of copolypropylene fibers with a titer of 2.2 dtex and a cut length of 40 mm. The melting temperature of the co-polypropylene fiber was about 5-7° C. below that of a highly drawn fiber polypropylene staple fiber.

The upper of the two rolls was the LineSeal engraved roll so that the staple fiber web faced the engraved roll.

The calender temperatures were 130° C. on the smooth roll and 127° C. on the LineSeal engraved roll, and the line pressure was 30 kp/cm.

The unwinding speed of the warp beam was 1.5 m/min, and the calender speed was 3 m/min.

The fabric was rolled up in a nearly tensionless manner and tested for its elastic elongation behavior after it had been stored for 7 days.

Visually, the composite fabric of Example 4 differed significantly from the composite fabrics according to Examples 1 through 3. The pleating on the side of spunbonded nonwoven fabric (=smooth roll side) was hardly recognizable, whereas the pleating on the staple fiber side having a weight of 18 g/m² was very pronounced. The differences in the characteristic of the pleating were probably mainly attributable to four factors

the differences in weight of the staple fiber web (18 g/m²) compared to the spunbonded nonwoven fabric layer (6 g/m²),

no pre-bonding of the staple fiber web, as opposed to the spunbonded nonwoven fabric,

crimped fibers in the staple fiber web, as opposed to flat fibers in the spunbonded nonwoven fabric,

the spunbonded nonwoven fabric layer faces the smooth roll.

With the composite fabric produced according to Example 4 being in a relaxed state, a weight per unit area of 67.8 g/m² was determined. The width of the embossed lines were measured in a color video picture. As already determined in Example 3, here too, it was found that the width of the embossed lines had shortened from originally B1=1.00 mm to an average of B2=0.852 mm, which is a result of the fact that the fabric had been rolled up in a tensionless manner. The maximum elongation m to the non-pleated stretch state was determined to be 116

From the established data, the proportions by weight of the individual components, i.e., spunbonded nonwoven fabric, staple fiber web, and elastane yarn in the maximally stretched, non-pleated state and after relaxation could be determined, as already explained in Example 3. The results were as follows:

Fv=0.963

F1=1.974 g/m²

F2=2.317 g/m²

F3s=2.347 g/m² for spunbonded nonwoven fabric (s for spunbonded nonwoven)

F3c=5.282 g/m² for staple fiber web (c for carded)

F4s=6.0 g/m²

F4c=13.50 g/m²

Thus, in the stretched state (i.e., in the non-pleated state of the layers of spunbonded nonwoven fabric and staple fiber web) of the composite fabric, which is elastic in the machine direction, the resulting weights per unit area of the three layers were as follows:

| | Weight per | Weight per |
|---|---|---|
| | unit area in | unit area in |
| Components of the composite fabric | g/0.963 m² | g/m² |
| Proportion by weight F4s of the PP | 6.000 | 6.231 |
| spunbonded nonwoven fabric layer in the | | |
| unembossed zones | | |
| Proportion by weight F3s of the PP | 2.347 | 2.437 |
| spunbonded nonwoven fabric layer in | | |
| embossed zone | | |
| 78 dtex elastane yarn layer F1 with | 1.974 | 2.050 |
| yarns/inch | | |
| Proportion by weight F3c of the staple | 5.282 | 5.485 |
| fiber web in embossed zones | | |
| Proportion by weight F4c of the staple | 13.50 | 14.019 |
| fiber web in the unembossed zones | | |
| Total | 29.103 | 30.22 |

Calculated weight per unit area in the relaxed state:

Gkr=30.22*2.16=65.28 g/m²

This calculated value of 65.28 g/m² agrees very well with the measured value of 67.80 g/m².

Measuring results of the hysteresis tests for a maximum elongation of 100%

| | Tensile force Z in N/25 mm | | | | | |
|---|---|---|---|---|---|---|
| | at different percentages of | | | | | |
| | elongation | | | | Elongation ε in % at | |
| hysteresis | 30% | 40% | 60% | 100% | 0.05 N/25 mm | 0.1 N/25 mm |
| cycle 1 | 0.38 | 0.45 | 0.61 | 1.63 | 0.00 | 130 |
| loading | | | | | | |
| cycle 1 | 0.17 | 0.23 | 0.35 | 1.49 | 15.30 | 20.20 |
| relaxation | | | | | | |
| cycle 2 | 0.26 | 0.32 | 0.47 | 1.29 | 5.90 | 11.20 |
| loading | | | | | | |
| cycle 2 | 0.17 | 0.22 | 0.33 | 1.28 | 15.40 | 21.80 |
| relaxation | | | | | | |
| cycle 3 | 0.28 | 0.34 | 0.50 | | 0.70 | 8.90 |
| loading | | | | | | |
| cycle 3 | 0.17 | 0.22 | 0.34 | | 14.00 | 20.50 |
| relaxation | | | | | | |

Measuring results of the hysteresis tests for a maximum elongation of 60%

| | Tensile force Z in N/25 mm | | | | |
|---|---|---|---|---|---|
| | at different percentages of | | | | |
| | elongation | | | Elongation ε in % at | |
| hysteresis | 30% | 40% | 60% | 0.05 N/25 mm | 0.1 N/25 mm |
| cycle 1 | 0.44 | 0.51 | 0.58 | 0.10 | 1.40 |
| loading | | | | | |
| cycle 1 | 0.28 | 0.41 | 0.60 | 4.60 | 11.30 |
| relaxation | | | | | |
| cycle 2 | 0.37 | 0.48 | 0.56 | 1.80 | 3.70 |
| loading | | | | | |
| cycle 2 | 0.30 | 0.35 | 0.59 | 7.50 | 11.60 |
| relaxation | | | | | |
| cycle 3 | 0.40 | 0.49 | 0.57 | 0.60 | 2.30 |
| loading | | | | | |
| cycle 3 | 0.30 | 0.38 | 0.61 | 5.10 | 10.20 |
| relaxation | | | | | |

Example 5 differed from Example 4 in that the unwinding speed of the elastane thread from the sectional warp beam was raised to 2.5 m/min. However, the calender speed of 3 m/min was retained.

In this manner, it was possible to achieve a composite fabric with markedly lower maximum elastic elongation, which was determined to be m=57.50%.

From the determined values

B1=1.00 mm

B2=0.942 mm

m=57.50

the proportions by weight of the individual components, i.e., spunbonded nonwoven fabric, staple fiber web, and elastane yarn in the maximally stretched, non-pleated state and after relaxation could be calculated again, as already explained in Example 4.

The results were as follows:

Fv=0.9855

F1=3.290

F2=1.411

F3s=2.123 g/m² for spunbonded nonwoven fabric (s for spunbonded nonwoven)

F3c=4.777 g/m² for staple fiber web (c for carded)

F4s=6.0 g/m²

F4c=13.50 g/m²

Thus, in the stretched state (i.e., in the non-pleated state of the layers of spunbonded nonwoven fabric and staple fiber web) of the composite fabric, which is elastic in the machine direction, the resulting weights per unit area of the three layers were as follows:

| | Weight per | Weight per |
|---|---|---|
| | unit area | unit area |
| Components of the composite fabric | in g/0.9855 m² | in g/m² |
| Proportion by weight F4s of the PP | 6.000 | 6.088 |
| spunbonded nonwoven fabric layer in the | | |
| unembossed zones | | |
| Proportion by weight F3s of the PP | 2.123 | 2.154 |
| spunbonded nonwoven fabric layer in | | |
| embossed zone | | |
| 78 dtex elastane yarn layer F1 with | 3.290 | 3.338 |
| yarns/inch | | |
| Proportion by weight F3c of the staple | 4.777 | 4.847 |
| fiber web in embossed zones | | |
| Proportion by weight F4c of the staple | 13.50 | 13.699 |
| fiber web in the unembossed zones | | |
| Total | 29.690 | 30.127 |

Thus, the weight per unit area in the relaxed state was calculated to be:

Gkr=30.127*1.575=47.45 g/m²

This calculated value differed slightly the measured value of 50.1 g/m².

What is claimed is:

1. A composite fabric comprising:
a planar structure;
a nonwoven fabric thermally bonded to the planar structure via a plurality of welds arranged in a predetermined pattern;
a sheet of parallel elastic threads disposed between the nonwoven fabric and the planar structure, wherein portions of the elastic threads are embedded in a stretched state in the plurality of welds.

2. The composite fabric as recited in claim 1, wherein the planar structure is one of a film and a second nonwoven fabric.

3. The composite fabric as recited in claim 1, wherein the nonwoven fabric includes white-pigmented fibers.

4. The composite fabric as recited in claim 1, wherein the nonwoven fabric includes at least one of a plurality of two-dimensionally crimped bicomponent fibers and a plurality of three-dimensionally crimped bicomponent fibers.

5. The composite fabric as recited in claim 1, wherein the nonwoven fabric includes at least one of a spunbonded nonwoven fabric and a staple fiber nonwoven fabric.

6. The composite fabric as recited in claim 1, wherein the planar structure is a film including a single polymer component having a melting range and a softening range, at least one of the melting range and the softening range of the film intersecting at least one of a melting range and a softening range of fibers of the nonwoven fabric.

7. The composite fabric as recited in claim 1, wherein the planar structure is a film including a first layer of a higher-melting polymer and a second layer of a lower-melting polymer; the lower-melting layer having a melting range and a softening range, at least one of the melting range and the softening range of the lower-melting layer intersecting at least one of a melting range and a softening range of fibers of the nonwoven fabric.

8. The composite fabric as recited in claim 6, wherein the fibers of the nonwoven fabric and the film include a same class of polymer material.

9. The composite fabric as recited in claim 8, wherein the polymer material includes at least one of a polypropylene and a copolymer of propylene with another olefin.

10. The composite fabric as recited in claim 6, wherein the film is a microporous film and the polymer component includes one of a hydrophobic polymer material and a second polymer material having a hydrophobic finish.

11. The composite fabric as recited in claim 1, wherein the elastic threads include at least one of a segmented polyester urea and a segmented polyurethane urea.

12. The composite fabric as recited in claim 1, wherein the elastic threads are spaced from each other by a distance of 1.0 to 10.0 mm.

13. The composite fabric as recited in claim 1, wherein the elastic threads include slit-film yarns.

14. The composite fabric as recited in claim 1, wherein a running direction of the sheet of elastic threads corresponds to the machine direction.

15. The composite fabric as recited in claim 1, wherein the planar structure is a second nonwoven fabric and further comprising a third layer covering one of the nonwoven fabric and the second nonwoven fabric.

16. The composite fabric as recited in claim 1, wherein the third layer is a third nonwoven fabric.

17. The composite fabric as recited in claim 1, wherein the elastic threads include a first polymer and at least one of the nonwoven fabric and the planar structure include a second polymer, wherein a combination first polymer/second polymer is selected from the group consisting of: polyurethanes/polyolefins, polyester elastomers/polyolefins, SBS/copolyester, SEBS/copolyester, SBS/copolyamide and SEBS/copolyamide.

18. The composite fabric as recited in claim 1, wherein the predetermined pattern includes parallel welds running at an angle of 30 to 90° to the direction of the elastic threads.

19. The composite fabric as recited in claim 1, wherein the composite fabric is part of a hygienic product.

20. The composite fabric as recited in claim 19, wherein the hygienic product is at least one of a diaper and a diaper pants.

21. A method for manufacturing the composite fabric as recited in claim 1, comprising the steps of:
a) disposing a sheet of parallel elastic threads between a nonwoven fabric and a planar structure in a stretched state, and
b) thermally bonding the nonwoven fabric to the planar structure in a plurality of welds arranged in a predetermined pattern so as to embed portions of each elastic thread in the stretched state between the nonwoven fabric and the planar structure.

22. The method as recited in claim 21, wherein the thermal bonding is performed using at least one of a heat, a calender pressure and an ultrasound.

23. The method as recited in claim 21, wherein the thermal bonding is performed by calendering using an embossing calender, wherein at least one roll of the calendar has an embossing pattern.

24. The method as recited in claim 23, wherein the embossing pattern is a continuous embossed line pattern and wherein a second roll has a smooth surface.

25. The method as recited in claim 23, wherein edges of the embossing pattern are rounded.
